(19) United States
(12) Patent Application Publication
(10) Pub. No.: US 2006/0206250 A1
(43) Pub. Date: Sep. 14, 2006

(54) Method for the control of a vehicle safety device

(76) Inventor: Abtin Darvish, Wuppertal (DE)

Correspondence Address: DELPHI TECHNOLOGIES, INC., M/C 480-410-202, PO BOX 5052, TROY, MI, 48007, US

(21) Appl. No.: 11/342,892

(22) Filed: Jan. 30, 2006

(30) Foreign Application Priority Data
Mar. 10, 2005 (EP) 05005262.0

(51) Int. Cl. E05F 15/00

(52) U.S. Cl. 701/45

(57) ABSTRACT

The invention relates to a method for the control of a vehicle safety device, wherein signals of at least two motion sensors are measured which are independent of one another in that they are designed or arranged for the measurement of movements of a different direction and/or type, the absolute amount of the signal of at least one motion sensor is compared with at least one threshold fixed for this signal, the absolute amount of the signal of at least a further one of the motion sensors is compared with a threshold fixed for this further motion sensor and the vehicle, movement is classified as critical or not critical in dependence on the comparison results.

### TECHNICAL FIELD

The invention relates to a method for the control of a vehicle safety device wherein signals from motion sensors are taken into account for the evaluation of the vehicle movement and to a vehicle safety device with which the method can be carried out and/or in which the method can be used.

### BACKGROUND OF THE INVENTION

A method of this type can be used, for example, to recognize whether a situation is present in which a roll movement or rollover movement of a motor vehicle is impending, in order to be able to initiate suitable safety measures as required. The trigger mechanisms for corresponding safety devices, such as for the deployment mechanism of a roll bar, for a belt tightener or for an airbag should then in particular be switched to “live”. The switching to “live” is also termed “arming”.

The safety system should e.g. always be armed when the vehicle movement is such that there is a risk of rolling over. The logic for the arming of the safety system must therefore be more sensitive than the trigger logic of the vehicle safety system itself which only engages when, for example, a rollover actually occurs.

The logic for arming may, however, not be so sensitive that the system is always armed. A permanently armed system would, for example, be detected as a defect in systems in which the functional capability is checked periodically and automatically.

There is a large risk of a permanent arming being present, for example, when driving over rough road surfaces. High vertical accelerations occur here without the risk of a rotary motion being present which could result in a rollover. Another situation in which there is a risk of permanent arming of the safety device is driving on a winding road, where the lateral forces can be very high.

### SUMMARY OF THE INVENTION

It is the object of the present invention to provide a method and a device with whose help a vehicle motion can be evaluated more reliably, in particular as to whether a critical situation is present or not.

This object is satisfied by a method having the features of claim 1 and a device having the features of claim 15. Dependent claims are directed to advantageous embodiments. A particularly advantageous use is the subject of claim 16.

In the method in accordance with the invention, the signals from at least two motion sensors are measured which are independent of one another in that they are arranged or designed for the measurement of movements of a different direction and/or type.

For example, the motion sensors can be selected or arranged such that they measure the lateral acceleration, the vertical acceleration and/or the longitudinal acceleration, that is accelerations in different directions. Motion sensors are provided or arranged in other embodiments in a manner to measure the angular speed about a lateral axis, about a longitudinal axis or about a vertical axis, that is the angular speed in different directions of rotation. In yet other embodiments, combinations of motion sensors of this type or of motion sensors arranged in this manner are used e.g. to evaluate the linear acceleration in a direction, on the one hand, and the angular speed about an axis, on the other hand. The invention is, however, not limited to these examples for the selection and/or arrangement of the motion sensors.

In the present text, the term “signal” in each case means the absolute amount of the measured signal.

The signals of the at least two independent motion sensors are compared with at least one respective threshold value associated with them. These comparisons are taken into account in the evaluation of the vehicle movement. The signals of at least two motion sensors measuring different movements are therefore used for the evaluation of the vehicle movement. The threshold values of the individual sensors can be selected to be low so that the individual measurement is not made too insensitive. It is, however, ensured that, e.g. when only one threshold for the signal of a motion sensor is exceeded, no classification as critical is yet made, but only when a further independent sensor also measures an exceeding of a threshold. Great stability against an unwanted classification as critical is therefore present despite the high sensitivity of the individual sensor measurement.

A safety device can be triggered directly on a classification as critical. The method can, however, particularly advantageously be used to determine whether a safety device should be armed, because no rollover is e.g. taking place, but is already impending.

Depending on the use or desired safety level, groups of thresholds are selected with respect to the signals of the independent sensors which each include at least two threshold values which are associated with independent sensors. A plurality of groups of this type can be fixed and a classification as critical can be made when the threshold values of one of the groups fixed in this manner are reached or exceeded. A plurality of thresholds of different amounts, which are classified in different groups, can be provided for the signal of a sensor.

With an embodiment of this type, a number of thresholds are e.g. fixed for each motion sensor. In this connection, it e.g. applies to the threshold values of an individual motion sensor that the rth threshold value is larger than the qth threshold when r is larger than q. In this embodiment, a vehicle movement is e.g. classified as critical when the absolute amount of the signal of at least one motion sensor reaches or exceeds an rth threshold associated with it and the absolute amount of the signal of at least one second motion sensor reaches or exceeds a qth threshold associated with it.

The rth threshold can be e.g. a respective “nominal” threshold value and the qth threshold can be a respective “minimal” threshold value for the signal of the respective motion sensor. A different number and classification of the threshold values for the signals of the individual motion sensors result in different examination sensitivities. The thresholds of the same number q, r, . . . of different motion sensors are not necessarily the same.

The method can, for example, be carried out such that, when a second threshold value for the signal of a first motion sensor is reached or exceeded, a check is made whether the first threshold for the signal of a second motion sensor, which is preferably smaller than a second threshold value for the signal of the second motion sensor, is reached or exceeded in order, if the answer is yes, to make a classification as critical.

A check is made in another embodiment whether the signals of at least two motion sensors reach or exceed the first, smaller threshold value respectively associated with them. If this is the case, a check is made whether one of the signals also exceeds the second, higher threshold value associated with it before the vehicle movement is classified as critical.

Preferred embodiments of the method in accordance with the invention use at least the signals of one motion sensor which measures the lateral acceleration and/or a motion sensor which measures the vertical acceleration. These accelerations are of priority significance particularly for the detection of a critical rolling movement of the vehicle. Other embodiments take account of the longitudinal acceleration of the vehicle or of the angular speed about a horizontal axis, about a vertical axis or about a longitudinal axis. With a corresponding embodiment of the evaluation, slanted directions and axes can also be used.

In a further development of the method in accordance with the invention, a boundary roll angle is set for the lateral vehicle inclination on whose reaching or exceeding the vehicle movement should be classified as critical in every case.

If e.g. motion sensors are provided which measure the lateral acceleration and/or the vertical acceleration, the lowest threshold value for the signal of the motion sensor which measures the lateral acceleration and/or the smallest threshold value for the signal of the motion sensor which measures the vertical acceleration is/are fixed such that a vehicle inclination equal to or larger than the boundary roll angle results in a classification as critical on the basis of the signal which is caused by the gravitational acceleration g in the coordinate system fixed with respect to the vehicle.

In an embodiment in which the lateral acceleration is evaluated, the lowest threshold value for the signal of the motion sensor which measures the lateral acceleration can, for this purpose, be set smaller than the amount of the product from the sinus value of the selected boundary roll angle with the gravitational acceleration. If the vehicle is in a rolling movement which signifies an inclination beyond this boundary roll angle, a lateral acceleration in the coordinate system fixed with respect to the vehicle already results from the gravitation acceleration which is larger than the amount of the product from the sinus of the boundary roll angle with the gravitational acceleration so that, in such a case, the vehicle movement is always classified as critical and a safety system is armed, for example.

Advantageously, the respectively lowest threshold values for the individual motion sensors are selected such that they are not smaller than the absolute amounts of typical signals which are caused by the respective motion sensor by a vehicle movement in a direction or manner which does not correspond to the direction or manner of the vehicle movement for whose measurement this motion sensor is designed or arranged. It is thus ensured that the lowest threshold values each lie above the cross axis sensitivity of the individual sensors.

A further preferred embodiment provides that the respective lowest threshold values are selected such that they are larger than the typical signal noise to prevent an erroneous classification of the vehicle movement taking place solely due to it.

A vehicle safety device in accordance with the invention includes at least two motion sensors, which are independent from one another in that they are designed or arranged for the measurement of vehicle movements of a different direction or type, a memory device for the storing of threshold values for the signals of the at least two independent motion sensors, a comparator for the comparison of the absolute amounts of the signals of the at least two motion sensors with in each case at least one associated threshold value, and an evaluation device for the classification of the vehicle movement as critical when the absolute amount of the signal of at least one motion sensor reaches or exceeds a threshold value associated with it and the absolute amount of the signal of at least one further motion sensor reaches or exceeds a threshold value associated with it.

The method in accordance with the invention can be carried out with the device in accordance with the invention and the advantages associated therewith can be achieved. Preferred embodiments of the device in accordance with the invention result in an analog manner from the preferred embodiments of the method in accordance with the invention.

### BRIEF DESCRIPTION OF THE DRAWINGS

The invention will be described in detail in the following with reference to exemplary embodiments and to the enclosed Figures. There are shown:

FIG. 1 is, schematically, a moving motor vehicle with a coordinate system;

FIG. 2 is a first embodiment of a logic for the carrying out of a method in accordance with the invention;

FIG. 3 is a second embodiment of a logic for the carrying out of a method in accordance with the invention;

FIG. 4 is a flowchart for the logic of FIG. 3;

FIG. 5 is a schematic explanation of a taking into account of a boundary roll angle;

FIG. 6 is the logic for a third embodiment of the method in accordance with the invention; and

FIG. 7 is the logic for the carrying out of a fourth embodiment of a method in accordance with the invention.

### DESCRIPTION OF THE PREFERRED EMBODIMENT

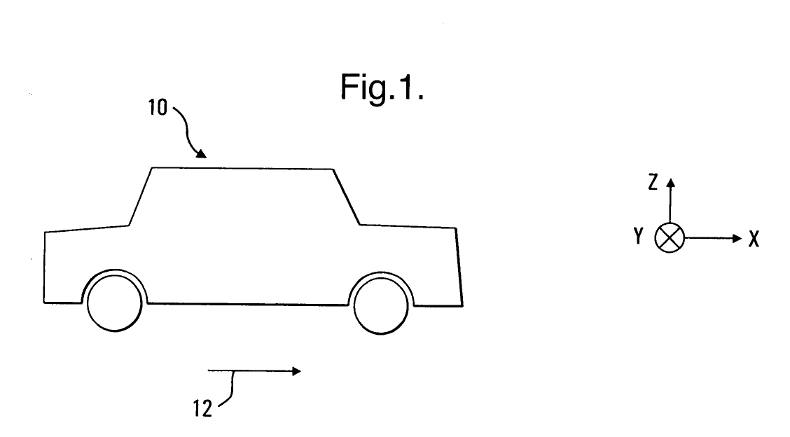

FIG. 1 shows a motor vehicle 10 moving in the direction 12. Furthermore, a coordinate system is given with the longitudinal axis X, a lateral axis Y, which faces into the plane of the Figure, and a vertical axis Z.

The coordinate system used here serves to present the physical state of affairs. It differs from the SAE convention where the X direction would be defined to the front, the Y direction from left to right and the Z direction downward. However, this is not important for the exemplary value ranges of the sensors given since only the absolute amounts are considered.

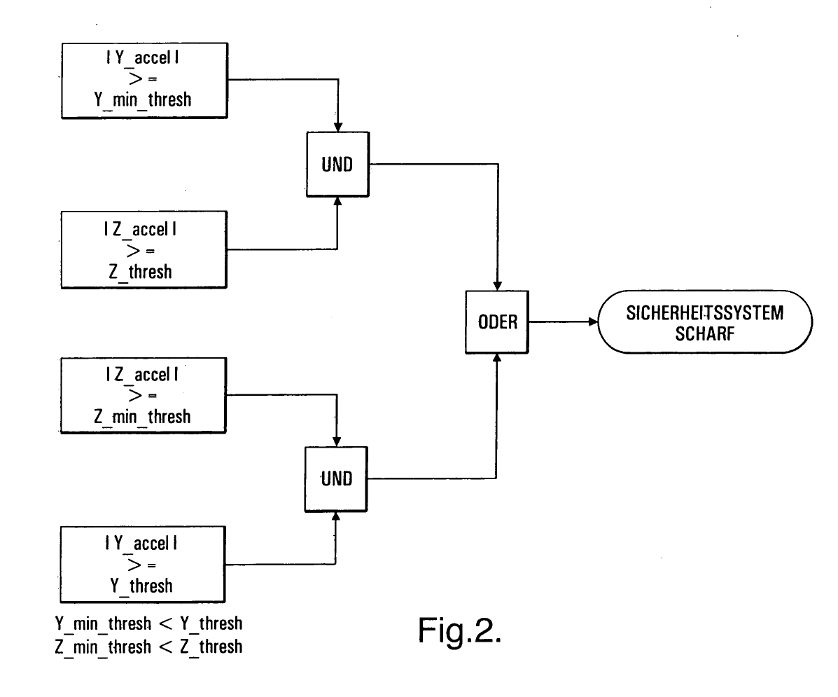

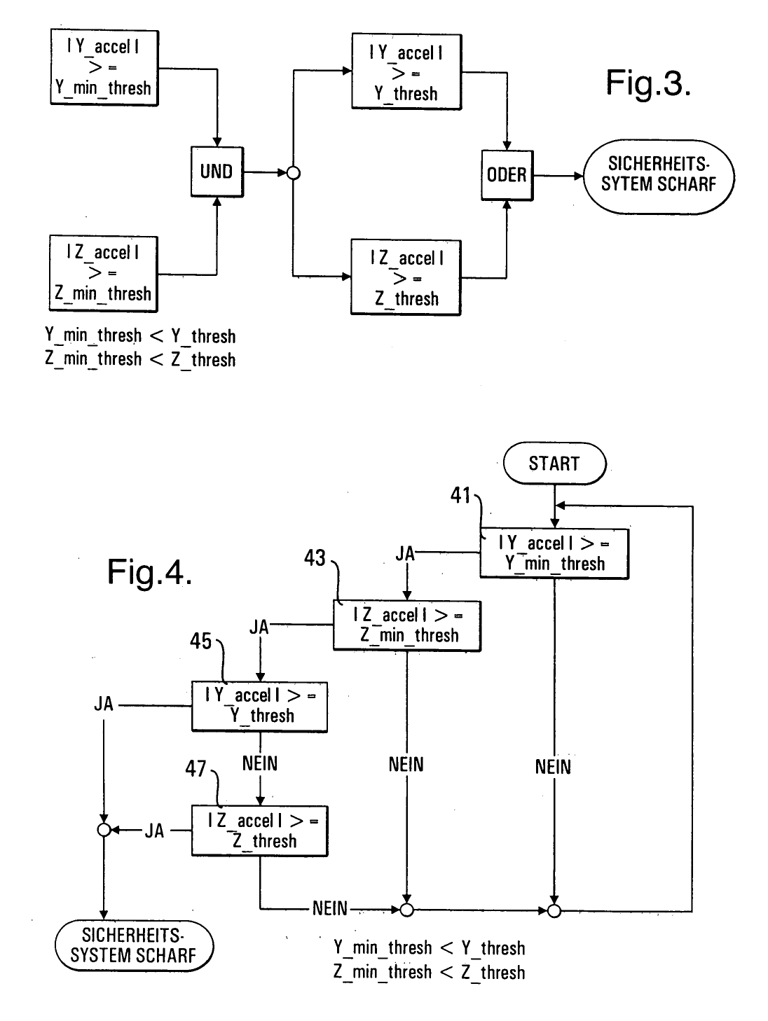

To carry out a method in accordance with FIGS. 2 or 3, this motor vehicle has an acceleration sensor for the measurement of the acceleration Y_accel in the Y direction and an acceleration sensor for the measurement of the acceleration Z_accel in the Z direction. The absolute amounts of the signals are used in the embodiments described even if this is not mentioned separately.

Threshold values for these accelerations are stored in a memory. A first threshold Y_min_thresh and a second threshold Y_thresh are in particular fixed for the acceleration in the Y direction, with Y_thresh being larger than Y_min_thresh. A first, smaller threshold value Z_min_thresh and a larger threshold Z_thresh are fixed for the acceleration in the Z direction. Y_thresh and Z_thresh, for example, designate nominal threshold values and Y_min_thresh and Z_min_thresh designate minimal thresholds.

The respective threshold values optionally take account of set offsets of the sensors. The sensor for the vertical acceleration can thus e.g. have an offset such that it is not the actually present gravitational acceleration g that is displayed in the state of rest, but the acceleration value zero.

Examples for the fixing of threshold values of this type are recited further below.

A processor unit in the motor vehicle constantly compares the measured acceleration values with these threshold values.

If the check in a method of FIG. 2, for example, results in the acceleration Y_accel in the Y direction being larger than or equal to Y_thresh and, simultaneously, the acceleration Z_accel in the Z direction being larger than or equal to Z_min_thresh and the acceleration in the Y direction being larger than or equal to Y_min_thresh, a safety system is armed.

With the logic of FIG. 3, an acceleration sensor is likewise used for the Y acceleration Y_accel and an acceleration sensor is used for the Z acceleration Z_accel. If the comparator determines that both Y_accel is larger than or equal to Y_min and Z_accel is larger than or equal to Z_min_thresh, a check is made whether either Y_accel is also larger than or equal to Y_thresh or Z_accel is larger than or equal to Z_thresh. If one of the two last named conditions is satisfied, the safety system is armed.

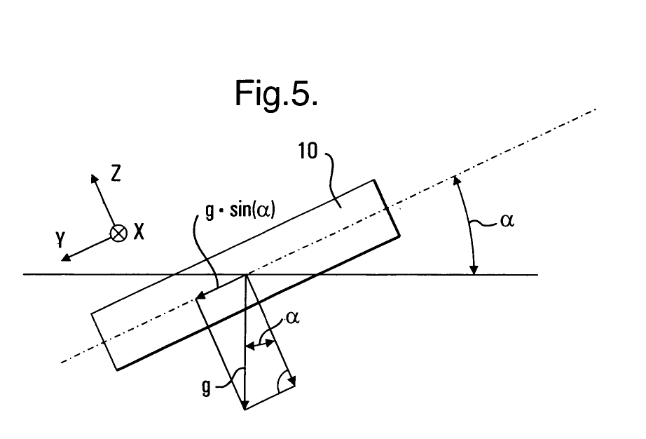

FIG. 4 shows a flowchart with which the logic of FIG. 3 can be shown. A check is first made in a step 41 whether the Y acceleration Y_accel is larger than or equal to Y_min_thresh. If this is the case, a check is made in step 43 whether the Z acceleration Z_accel is greater than or equal to Z_min_thresh. Only if this is also the case is a check made at 45 whether the Y acceleration Y_accel is also larger than or equal to Y_thresh. If this is the case, the safety system is armed. If the check in step 45 is negative, a check is made in step 47 whether the acceleration in the Z direction Z_accel is larger than or equal to Z_thresh. If this is so, the safety system is armed. Only if this check 47 also turns out negative does the system remain in the non-armed state.

The logics of FIGS. 2 and 3 or the algorithm of FIG. 4, for example, ensure that a discrimination can be made between an uncritical vertical acceleration, for example by a rough road surface, and a dangerous roll movement. Driving over a rough surface, for example, brings about vertical acceleration values which are larger than Z_thresh. Only when the Y acceleration Y_accel is simultaneously larger than or equal to the threshold value Y_min_thresh for the Y acceleration is the safety system armed, e.g. corresponding to the top half of FIG. 2. Such additional accelerations in the lateral direction occur, for example, when the vehicle is very inclined and a rollover is impending.

If the vehicle, on the other hand, is traveling fast round a curve, Y accelerations Y_accel occur which are larger than the limit value Y_thresh. Only when accelerations occur in the vertical direction and simultaneously Z_accel is larger than or equal to Z_min_thresh, however, is the system armed, since evidently a rollover is impending (bottom half of FIG. 2). When traveling normally fast around a curve, where only strong lateral accelerations occur without a strong vertical acceleration occurring, the safety system remains in the unarmed state.

A comparable result is achieved when the logic of FIG. 3 is used. Here, the accelerations in the Y and Z directions are first checked as to whether they are larger than or equal to the respective smaller threshold values Y_min_thresh and Z_min_thresh respectively. If the check shows that both acceleration values are larger than the respective smaller threshold values, a check is made as to whether one of the acceleration values is larger than or equal to the larger threshold Y_thresh or Z_thresh associated with it. In this case, the safety system is armed.

The determination of the threshold values can take place as follows: First, for example, a boundary roll angle a is set and the check routine of the invention should be initiated in every case when this is exceeded. Reference is made to FIG. 5 for explanation purposes in that a vehicle 10 is shown schematically which is moving in the X direction. A coordinate system is moreover shown in FIG. 5 which is valid in the vehicle. The X direction faces into the plane.

The gravitational acceleration g is given. If the signal of the motion sensor for the lateral movement in the Y direction triggered solely by the gravitational acceleration is larger than the absolute amount of g·sin (α), the method in accordance with the invention should start in every case. In this respect, the first, smaller threshold value for the lateral acceleration should in every case be smaller than or equal to the absolute amount of g·sin (α). If, for example 20° or −20° is assumed as the boundary roll angle, the first, smaller threshold value Y_min_thresh should accordingly be smaller than or equal to 0.3 g.

Similarly, a setting can be made for the smaller limit value Z_min. In this connection, it is assumed for this example that the motion sensor for the measurement of the vertical acceleration value in the vehicle is “compensated”. For this purpose, the sensor internally adds the simple gravitational acceleration g to the measured signal so that, in the sensor state of rest at a vehicle inclination of 0°, the vertical acceleration is given as zero instead of −1 g. So that a lateral vehicle inclination larger than a boundary roll angle α is classified as critical in every case, the smaller threshold value Z_min_thresh for the vertical movement is selected to be smaller than or equal to (1-cos (α)). If 20° or −20° is again assumed as the boundary roll angle, the first, smaller limit value Z_min_thresh should accordingly be smaller than or equal to 0.06 g.

The above determination does not preclude the minimal threshold set in this manner in each case already being exceeded with smaller vehicle inclinations in dynamic driving situations if additional acceleration values result —in addition to the acceleration values caused by the gravitational acceleration—due to the driving situation.

The cross axis sensitivity of the two sensors can moreover be taken into account. Typical vibrations of a rough road surface do not as a rule exceed vertical accelerations of 2 g. If a cross axis sensitivity of the sensors of 4% is assumed, vertical accelerations of 2 g result in a signal at the motion sensor for the lateral acceleration of (2 g)·0.04=0.08 g. The first, smaller threshold value Y_min_thresh for the acceleration in the Y direction should therefore be larger than 0.08 g.

Lateral accelerations on very winding roads are as a rule not larger than 1 g. Under the assumption of a cross axis sensitivity of 4%, these result in a signal at the motion sensor for the Z acceleration of (1 g)·0.04=0.04 g. The first, smaller threshold value Z_min_thresh for the acceleration in the Z direction should accordingly be larger than or equal to 0.04 g.

Finally, the effect of the signal noise should also not result in defective signals. If it is, for example, assumed that the acceleration sensor for the lateral movement has a measuring range of ±7 g at a resolution of 10 bits, then a count pulse approximately corresponds to (2·7 g)/1024=0.014 g. With a typical assumed noise of 4 count pulses, the first smaller threshold Y_min_thresh for the lateral acceleration should accordingly be larger than or equal to 0.014 g·4=0.06 g.

Assuming that the acceleration sensor for the vertical acceleration has a measuring range of ±2.5 g and a resolution of 10 bits, a count pulse corresponds approximately to (2·2.5 g/1024=0.005 g. The first, smaller threshold value Z_min_thresh for the acceleration in the Z direction should accordingly be larger than 0.005 g·4=0.02 g if a typical noise of 4 count pulses should not be evaluated as a signal.

In combination, it results from these typical exemplary assumptions that the respective first, smaller threshold values should satisfy the following conditions:

Y_min_thresh≦0.3 g

Z_min_thresh<0.06 g

Y_min_thresh≧0.08 g

Z_min_thresh≧0.04 g

Y_min_thresh≧0.06 g

Z_min_thresh≧0.02 g.

These conditions are satisfied, for example, when Z_min_thresh is selected to be equal to 0.06 g and Y_min_thresh is selected to be equal to 0.3 g. Z_thresh can be selected to be equal to 0.12 g and Y_thresh can be selected to be equal 1 g as the respectively larger limit values.

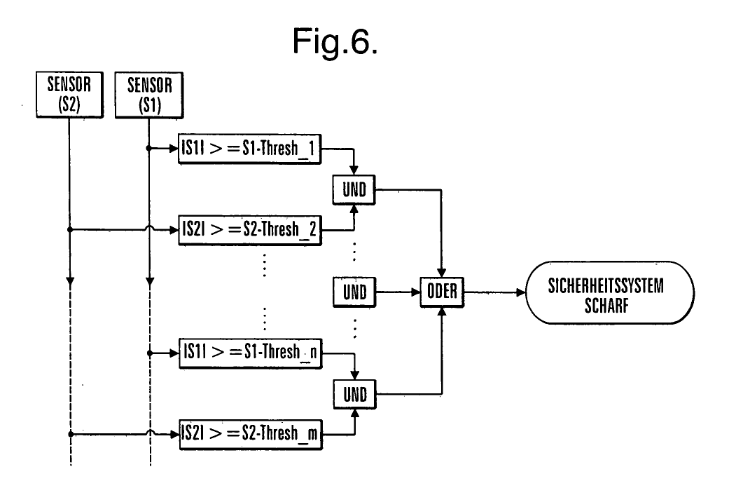

The previously described embodiments of the method use two sensors, each with two threshold values. It is, however, equally possible for a higher number of threshold values to be used for a sensor, as is shown in FIG. 6.

Two sensors S1 and S2 are provided here. A plurality of threshold values are associated with each of these sensors. The individual threshold values for the signal of the sensor S1 are given as S1-Thresh_{—}1, S1-Thresh_{—}2, . . . S1-Thresh_n, . . . and the individual threshold values for the signal of the sensor S2 correspondingly as S2-Thresh_{—}1, S2-Thresh_{—}2, . . . , S2-Thresh_m . . . .

Depending on what type of sensors are provided and which travel situations should be detected, a plurality of different combinations of sensor exceeding events are set as conditions for the arming of the safety system.

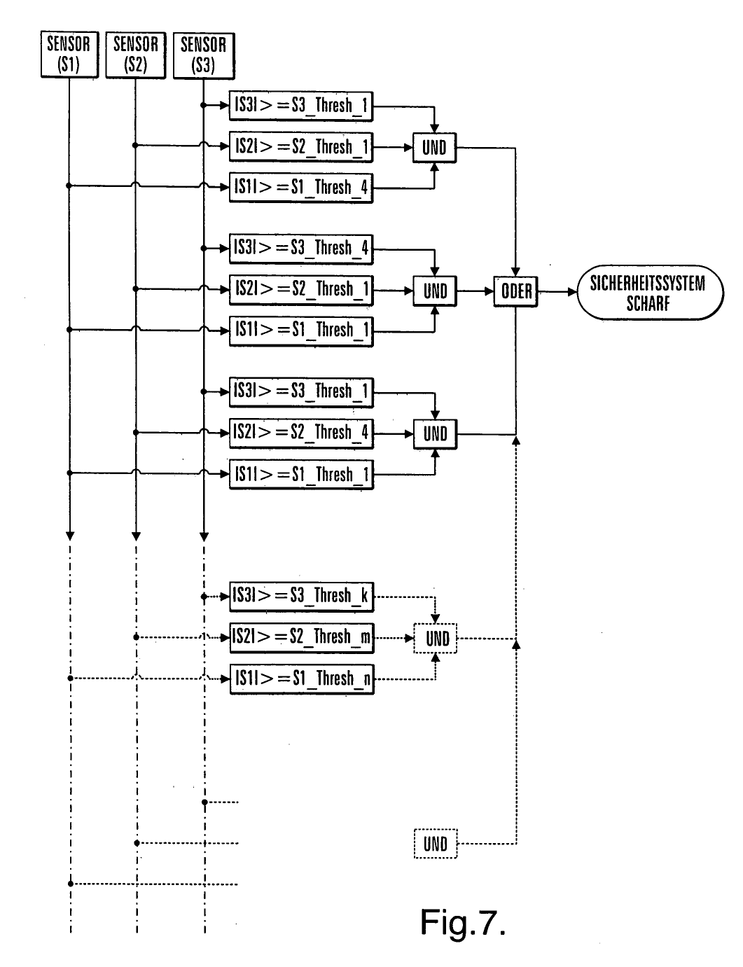

More than two sensors can moreover also be used. FIG. 7 shows an example with three sensors S1, S2, S3. Threshold values S1-Thresh_{—}1, S1-Thresh_n, . . . are provided for the signal of the sensor S1. Threshold values S2-Thresh_{—}1 . . . , S2-Thresh_m, . . . are provided for the signal of the sensor S2. Finally, threshold values S3_Thresh_{—}1, . . . S3_Thresh_k, . . . are provided for the sensor S3. As is shown by way of example in FIG. 7, different combinations of exceeded limit values can result in the arming of the safety system in dependence on the type of the sensors and the travel situations to be checked. The selection of the combinations is set in dependence on the travel situations to be checked.

The invention is not limited to only accelerations sensors being used for the measurement of the lateral acceleration, the vertical acceleration or the longitudinal acceleration. Other embodiments e.g. use sensors either exclusively or additionally which measure the angular speed about the vertical axis, the horizontal axis or the longitudinal axis.

As can also be seen from the described embodiments, the invention has the effect that a travel situation is only classified as critical and e.g. a safety system is armed when, on the detection of the exceeding of a nominal threshold value of a motion sensor, at least one threshold of at least one further motion sensor is also exceeded which is smaller than the nominal threshold for this further motion sensor.

1. A method for the control of a vehicle safety device comprising the following steps:
measuring the signals (Y_accel, Z_accel) of at least two motion sensors which are independent of one another in that they are arranged or designed for the measurement of movements in a different direction and/or for the measurement of movements of a different type;
comparing the absolute amount of the signal (Y_accel; Z_accel) of at least one of the motion sensors with at least one threshold value (Y_thresh; Z_thresh) fixed for this signal;
comparing the absolute amount of the signal (Z_accel; Y_accel) of at least a further one of the motion sensors with at least one threshold value (Z_min_thresh; Y_min_thresh) fixed for this signal; and
classifying a vehicle movement as critical or non-critical in dependence on the comparison results.

2. A method in accordance with claim 1, wherein a vehicle safety device is armed when the vehicle movement is classified as critical.

3. A method in accordance with any one of the claim 1, wherein groups of threshold values are fixed which each include at least two threshold values which are associated with independent motion sensors, with a vehicle movement being classified as critical when at least the absolute amounts of the signals of the motion sensors with which the threshold values of a group are associated are reached or exceeded.

4. A method in accordance with any one of the claim 1, wherein a number of threshold values is set for each motion sensor and the vehicle movement is classified as critical when the absolute amount of the signal of at least one motion sensor reaches or exceeds an rth threshold value associated with it and the absolute amount of the signal of at least one second motion sensor reaches or exceeds a qth threshold value associated with it, with it preferably applying to the threshold values which are associated with a motion sensor that the rth threshold value is larger than the qth threshold value when r is larger than q.

5. A method in accordance with any one of the claim 1, wherein the vehicle movement is classified as critical when the absolute amount of the signal of at least one motion sensor reaches or exceeds a second threshold value (Y_thresh; Z_thresh) associated with it and the absolute amount of the signal of at least one further motion sensor reaches or exceeds a first threshold value (Z_min_thresh; Y_min_thresh) which is associated with it and which is preferably smaller than a second threshold value associated with the further motion sensor.

6. A method in accordance with any one of the claim 1, wherein the vehicle movement is classified as critical when the absolute amounts of the signals of at least two motion sensors reach or exceed a first threshold value (Y_min_thresh; Z_min_thresh) respectively associated with them and the absolute amount of the signal of at least one of the motion sensors reaches or exceeds a second threshold value (Y_thresh; Z_thresh) which is associated with it and which is preferably selected such that it is larger than the first threshold value associated with this motion sensor.

7. A method in accordance with any one of the claim 1, wherein the signals used include at least one signal (Y_accel) of a motion sensor which measures the lateral acceleration.

8. A method in accordance with claim 7, wherein the smallest threshold value (Y_min_thresh) for the signal of the motion sensor which measures the lateral acceleration is set such that, when a set boundary roll angle (α) is exceeded or reached, the vehicle movement is classified as critical in every case, preferably in that the smallest threshold value (Y_min_thresh) for the signal of the motion sensor which measures the lateral acceleration is set smaller than or equal to the absolute amount of the product of the sinus value of the boundary roll angle (α) with the gravitational acceleration (g).

9. A method in accordance with any one of the claim 1, wherein the signals used include at least one signal (Z_accel) of a motion sensor which measures the vertical acceleration.

10. A method in accordance with claim 9, wherein the smallest threshold value (Z_min_thresh) for the signal of the motion sensor which measures the vertical acceleration is set such that, when a set boundary roll angle (α) is reached or exceeded, the vehicle movement is classified as critical in every case.

11. A method in accordance with any one of the claim 1, wherein the signals used include at least one signal (X_accel) of a motion sensor which measures the longitudinal acceleration.

12. A method in accordance with any one of the claim 1, wherein the signals used include at least one signal from a motion sensor which measures the angular speed about a horizontal transverse axis (Y axis) and/or at least one signal from a motion sensor which measures the angular speed about a vertical axis (Z axis) and/or at least one signal from a motion sensor which measures the angular acceleration about a longitudinal axis (X axis).

13. A method in accordance with any one of the claim 1, wherein the respective smallest threshold value (Y_min_thresh, Z_min_thresh) associated with a signal of a motion sensor is selected such that it is not smaller than the absolute amounts of typical signals which are caused in this motion sensor by a vehicle movement in a direction or of a type which does not correspond to the direction or the type of the vehicle measurement for whose measurement this motion sensor is arranged or designed.

14. A method in accordance with any one of the claim 1, wherein the respective smallest threshold (Y_min_thresh, Z_min_thresh) associated with a signal of a motion sensor is selected such that it is larger than the typical signal noise.

15. A vehicle safety device comprising:
at least two motion sensors which are arranged or designed independently of one another in that they can serve for the measurement of movements in different directions and/or for the measurement of movements of different types;
a memory device for the storage of threshold values for the signals of the at least two independent motion sensors;
a comparator for the comparison of the absolute amounts of the signals of the at least two motion sensors with threshold values;
an evaluation device for the classification of the vehicle movement as critical when the absolute amount of the signal of at least one motion sensor reaches or exceeds a threshold value associated with it and the absolute amount of the signal of at least one further motion sensor reaches or exceeds a threshold value associated with it.

16. Use of a method in accordance with claim 1 for the evaluation of whether a roll movement or rollover movement of a vehicle is impending.
